(19) United States
(12) Patent Application Publication
(10) Pub. No.: US 2015/0092996 A1
(43) Pub. Date: Apr. 2, 2015

(54) AUTHENTICATION APPARATUS, AUTHENTICATION SYSTEM, AND AUTHENTICATION METHOD

(71) Applicant: KABUSHIKI KAISHA TOSHIBA, Tokyo (JP)

(72) Inventor: Guifen TIAN, Yokohama Kanagawa (JP)

(21) Appl. No.: 14/475,483

(22) Filed: Sep. 2, 2014

(30) Foreign Application Priority Data
Sep. 30, 2013 (JP) 2013-205515

(51) Int. Cl. G06K 9/00

(52) U.S. Cl. CPC G06K 9/00288
USPC 382/118

(57) ABSTRACT

An authentication apparatus includes first and second storage units in which feature data of different authentication targets are stored, a feature extraction unit that extracts feature data of a subject from an image including the subject, a recognition unit that compares the extracted feature data of the subject and the feature data of the authentication targets stored in the first storage unit and the second storage unit to generate similarity results, and recognize one of the authentication targets as the subject based on the comparison results, and an update unit that updates the feature data stored in the second storage unit with the extracted feature data of the subject based on the comparison results.

### CROSS-REFERENCE TO RELATED APPLICATION

This application is based upon and claims the benefit of priority from Japanese Patent Application No. 2013-205515, filed Sep. 30, 2013, the entire contents of which are incorporated herein by reference.

### FIELD

Embodiments described herein relate generally to an authentication apparatus, an authentication system, and an authentication method.

### BACKGROUND

An authentication apparatus that determines which one of authentication targets registered in advance matches a captured image of a subject is known in the art. In such an authentication apparatus, it is necessary for the subject to be accurately authenticated even when there is a slight change in the subject's appearance.

### DESCRIPTION OF THE DRAWINGS

FIG. 1 is a schematic block diagram of an authentication system according to a first embodiment.

FIG. 2 is a flow chart illustrating an example of a processing operation of an authentication apparatus during an advance registration process.

FIG. 3 is a view illustrating a face region detected by a face detection unit.

FIG. 4 is a view illustrating an example of configuring the parts detected by the part detection unit detects.

FIG. 5 is a table schematically illustrating an example data structure maintained by an advance information storing unit.

FIG. 6 is a view illustrating an example of the processing operation of the authentication apparatus in an authentication process.

FIG. 7 is a flow chart illustrating a feature vector replacing step of FIG. 6 in detail.

FIG. 8 is a view illustrating relationships among different threshold values.

FIGS. 9A to 9C are views illustrating an effect of updating a feature vector.

FIG. 10 is a flow chart illustrating an example of the processing operation of the authentication apparatus in the authentication process according to a second embodiment.

FIG. 11 is a conceptual diagram illustrating an effect of the second embodiment.

### DETAILED DESCRIPTION

Embodiments provide an authentication apparatus, an authentication system and an authentication method in which a subject may be accurately authenticated.

In general, according to one embodiment, there is provided an authentication apparatus including first and second storage units in which feature data of different authentication targets are stored, a feature extraction unit that extracts feature data of a subject from an image including the subject, a recognition unit that compares the extracted feature data of the subject and the feature data of the authentication targets stored in the first storage unit and the second storage unit to generate similarity results, and recognize one of the authentication targets as the subject based on the comparison results, and an update unit that updates the feature data stored in the second storage unit with the extracted feature data of the subject based on the comparison results.

Hereinafter, embodiments will be specifically described with reference to the drawings.

### First Embodiment

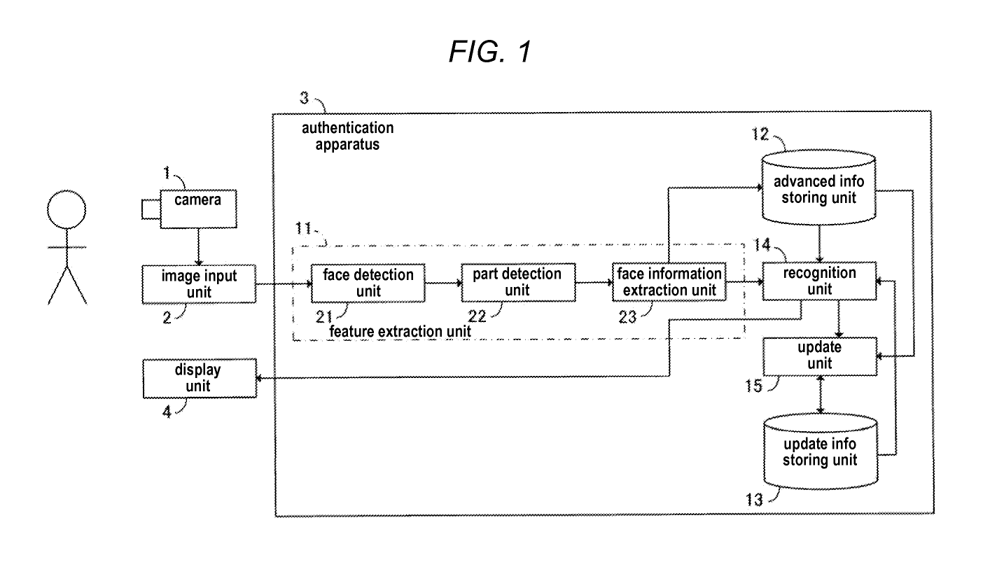

FIG. 1 is a schematic block diagram of an authentication system according to a first embodiment. In the present authentication system, feature vectors of N users (hereinafter, referred to as user Uk (k=1 to N)) are registered as authentication targets in advance through an advance registration process. Thereafter, an authentication process authenticates which one of the registered authentication targets in the number of N matches a subject. In the authentication process, the feature vectors of the subject are updated as necessary.

As illustrated in FIG. 1, the authentication system includes a camera 1, an image input unit 2, an authentication apparatus 3 and a display unit (output unit) 4.

The camera 1 captures a face image as information of the subject at a predetermined angle, thereby forming an image. The image input unit 2 separates luminance information from an image received from the camera 1, thereby forming an image with a grayscale luminance. The image with a grayscale luminance is input to the authentication apparatus 3.

The authentication apparatus 3 has a feature extraction unit 11, an advance information storing unit (first storage unit) 12, an update information storing unit (second storage unit) 13, a recognition unit 14 and an update unit 15.

The feature extraction unit 11 extracts feature data from the image with a grayscale luminance. More specifically, when the information of the subject is the face, the feature extraction unit 11 has a face detection unit 21, a part detection unit 22 and a face information extraction unit 23. The face detection unit 21 detects the face from an image with a grayscale luminance which is received from the image input unit 2, thereby setting a part detection target image. The part detection unit 22 detects parts of the face such as the eye, the mouth and the like from the part detection target image. The face information extraction unit 23 generates a feature vector fv which indicates a feature of the face based on a position of the parts. The feature vector is an example of feature data.

During the advance registration process, the advance information storing unit 12 stores the feature vectors as extracted by the feature extraction unit 11 (the number of feature vectors being equal to M1) for each of users U1 to UN.

During the authentication process, the update information storing unit 13 may additionally store the feature vectors (the number of feature vectors that can be additionally stored being equal to a maximum of M2) for each of the users U1 to UN.

During the authentication process, the recognition unit 14 recognizes which one of the users U1 to UN matches the subject which the camera 1 has captured by comparing the feature vector which the feature extraction unit 11 extracts and the feature vectors which are stored in the advance information storing unit 12 and the update information storing unit 13. The recognized result is displayed on the display unit 4. Notification of the recognized result may be expressed through a sound and the like and differently for completion or failure of the authentication.

The update unit 15 updates stored contents of the update information storing unit 13 as necessary based on an authenticated result. The updating of the stored contents means that the feature vector is newly added to be stored, or the feature vector stored previously is deleted to be replaced (that is, to be overwritten) with another feature vector.

As a characteristic of the present embodiment, during the authentication process, the update unit 15 updates the stored contents of the update information storing unit 13 without updating the stored contents of the advance information storing unit 12. It is possible to suppress erroneous authentication from being generated by leaving the feature vector stored through the advance registration process without deleting.

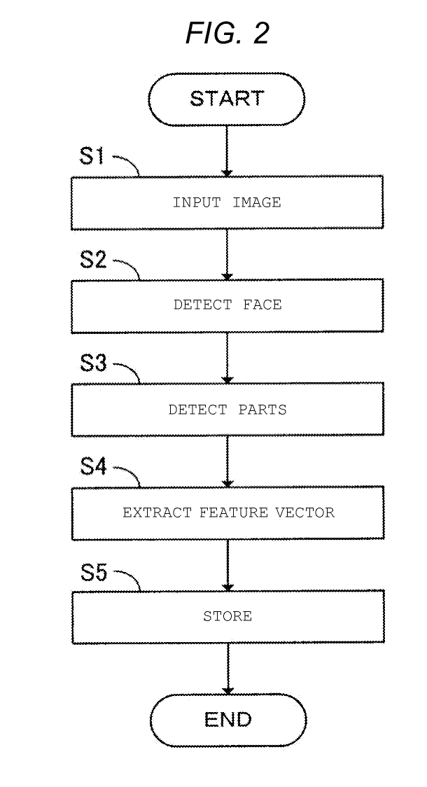

FIG. 2 is a flow chart illustrating an example of processing of the authentication apparatus 3 during the advance registration process. First, an image with a grayscale luminance including the face of the subject captured by the camera 1 is input to the authentication apparatus 3 through the image input unit 2 (S1).

Then, the face detection unit 21 detects the face from the image with a grayscale luminance and sets the part detection target image based on a position of the face region (S2). Known face detection algorithm may be applied to the face detecting. Hereinafter, a specific example of a method that sets a part detection target image will be described.

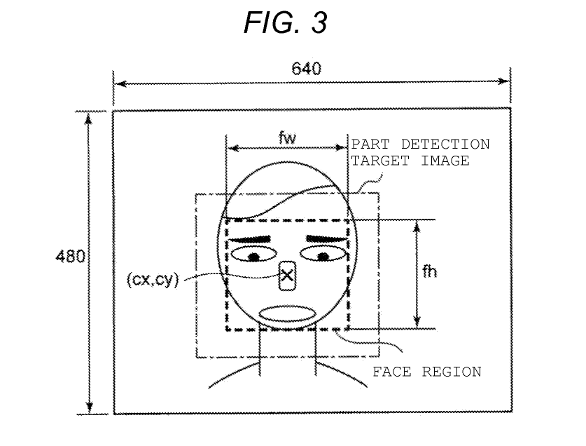

FIG. 3 is a view illustrating an example of a face region detected by the face detection unit 21. The portion surrounded by a dotted line is the face region. The width fw of the face region is determined based on positions of outer corners of the eyes on the right and left, and the height fh is determined based on positions of upper portions of the eyebrows and the mouth. Here, the center of the face region is set to be (cx, cy).

Then, the face detection unit 21 cuts off a region with a width and a height of 2*max (fw, fh) having a center of (cx, cy) to obtain the part detection target image. The portion surrounded by an alternate long and short dash line in FIG. 3 is the part detection target image. It is possible to detect apart to be the feature thereof by obtaining the region larger than the face region as the part detection target image even when the part to be the feature is not included in the face region.

Moreover, the face detection unit 21 may resize the part detection target image to be a fixed size. For example, when a resolution of an image with a grayscale luminance is 640 pixels (horizontal direction) by 480 pixels (vertical direction), the face detection unit 21 resizes the region of the part detection target image to be 200 pixels by 200 pixels. It is possible to detect the part more efficiently and accurately through resizing the region of the part detection target image. The resizing method is not particularly limited. However, for example, a linear interpolation method may be adopted for reduction, or a bicubic method may be adopted for enlargement. The part detection target image is input to the part detection unit 22.

Subsequently, the part detection unit 22 detects a part to be a feature of the face from the part detection target image (S3). Known part detection algorithm may be applied to the part detecting. Hereinafter, a specific example of a part detection method will be described.

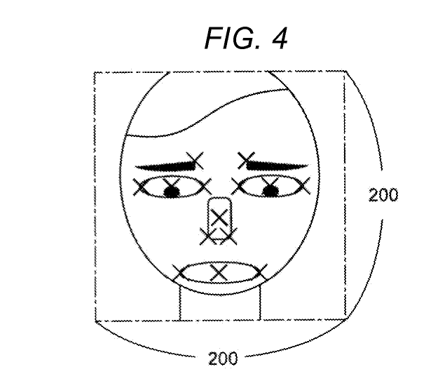

FIG. 4 is a view illustrating an example of configuring the parts detected by the part detection unit 22. As indicated by X marks in FIG. 4, the parts may include fourteen spots in total such as two spots on the pupils, two spots on inner ends of the eyebrows, two spots on inner corners of the eyes, two spots on the outer corners of the eyes, two spots on the nostrils, one spot on the tip of the nose, two spots on corners of the mouth, one spot on the center of the mouth. Naturally, a portion thereof may be omitted, and another part may be detected.

Here, it is considered that a direction of a face is not constant in accordance with a posture of a subject when the camera 1 captures the subject. Therefore, in order to improve the authentication rate with respect to the various directions of the face, it is preferable for the part detection unit 22 to normalize the part detection target image in a predetermined direction (for example, the front with respect to camera 1).

As an example of normalizing, it is possible to employ a three-dimensional face model. In other words, the part detection unit 22 carries out a linear transformation between an average position of each part in the three-dimensional face model and a position of a detected part, thereby fitting a position of the part detection target image on the three-dimensional face model. More specifically, the part detection unit 22 calculates a transformation matrix in which a squared error between the part detection target image and the three-dimensional face model is the minimum, thereby estimating a texture on the three-dimensional face model from the part detection target image. Then, the part detection unit 22 rotates the part detection target image in a predetermined direction, thereby forming a normalized image in a fixed size in which the face is oriented in a predetermined direction.

Subsequently, the face information extraction unit 23 extracts the feature vector from the normalized image as face information based on the position of the detected part (S4). Known face information extraction algorithm may be applied to the face information extracting. Hereinafter, an example of a method extracting a feature vector will be described.

The face information extraction unit 23 extracts oval-shaped image regions which respectively include each of the parts as the center from the normalized image. Then, the face information extraction unit 23 carries out a one-dimensional Gabor wavelet transformation in a transverse direction through sub-band decomposition with respect to the cut-off image region, thereby decomposing into a low-frequency component and a high-frequency component. Subsequently, the face information extraction unit 23 carries out the one-dimensional Gabor wavelet transformation in the vertical direction. Accordingly, it is possible to obtain a transformed image which is divided into 2×2 regions.

A combination with four components of every divided region of the transformed image becomes the feature vector fv. The number of a scale and a direction of an oval may be appropriately determined in accordance with usage. In addition, in place of the Gabor wavelet transformation, the feature vector may be extracted through another method such as a Haar wavelet transformation, a DCT transformation or Eigenface.

Then, the feature vector extracted in this manner is stored in the advance information storing unit 12 (S5). More specifically, the advance information storing unit 12 associates a user being the subject with a unique ID (hereinafter, referred to as user ID), thereby storing the extracted feature vector. As the user ID, a controller of the authentication apparatus 3 may issue the number, or a user may arbitrarily issue the number.

As described above, with respect to one user, the advance information storing unit 12 stores M1 feature vectors in obtained from the images which are in a state mutually different in an orientation of the face, a facial expression, a luminous environment and the like. Such a processing is carried out with respect to the N users.

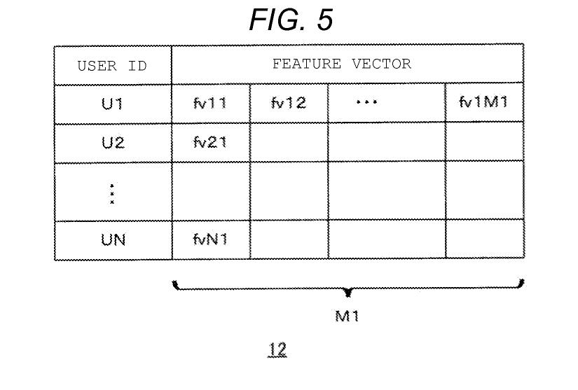

FIG. 5 is a table schematically illustrating an example of a structure of data which the advance information storing unit 12 stores. In the table, a j-th (j=1 to M1) feature vector of the user Uk is represented as fvkj. It is desirable that the number M1 of the storable feature vectors be as large as possible because the accuracy of the authentication may be improved by storing many feature vectors extracted from the images which are captured under various conditions of the orientation of the face, the facial expression and the luminous environment. However, when it is difficult to set the number M1 of the feature vectors to be large for the reason of a limited capacity of the advance information storing unit 12 or balancing with the number N of the user, the number of the storable feature vector may be one or a small number.

Here, since the feature vector stored in the advance information storing unit 12 is fixed data, when the feature vector is stored once through the advance registration process, the feature vector is not deleted or a new feature vector added. However, the advance information storing unit 12 may be enabled to be editable such that the stored feature vector may be deleted or a new feature vector may be added.

Subsequently, the authentication process will be described. First, the update information storing unit 13 which may be updated through the authentication process will be described. The update information storing unit 13 may store M2 feature vectors that are associated with the user ID. Accordingly, the number of feature vectors that may be stored in total in the advance information storing unit 12 and the update information storing unit 13 per user is equal to M (M=M1+M2).

Hereinafter, the j-th feature vector of the user Uk stored in the update information storing unit 13 is represented as fvk (M1+j) and caused to be serial in number to the feature vectors stored in the advance information storing unit 12.

The advance information storing unit 12 stores the M1 feature vectors in advance in the advance registration process. Meanwhile, feature vectors are additionally stored in the update information storing unit 13 by the update unit 15 through the authentication process as necessary. In other words, the update information storing unit 13 does not store the feature vectors when the authentication apparatus 3 is initially used, but feature vectors are additionally stored therein as the apparatus is being used.

The number of feature vectors that can be added is M2 per user. Accordingly, when the number of the feature vector which is added to the update information storing unit 13 is less than M2 per one user, a new feature vector may be added thereto. Meanwhile, when the number of the added feature vector reaches M2, it is not possible to add more than M2. In this case, the new feature vector is not added thereto, or one of the feature vectors stored previously is deleted to be replaced with the new feature vector.

Contrary to a case where the stored contents are not updated when the feature vectors are stored in the advance information storing unit 12 through the advance registration process, the feature vectors stored in the update information storing unit 13 is not the fixed data, and thus, the stored contents may be changed by the update unit 15. In this regard, the role of the advance information storing unit 12 is different from that of the update information storing unit 13.

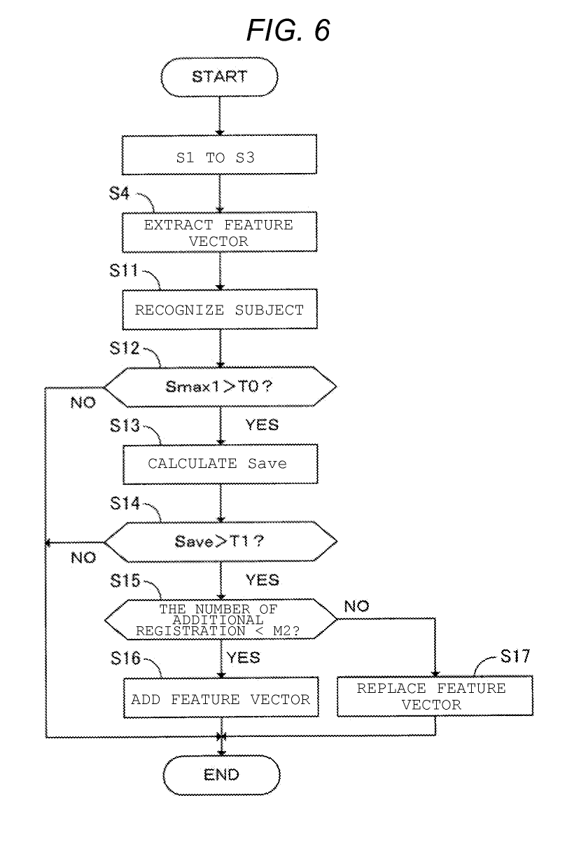

FIG. 6 is a view illustrating an example of the processing of the authentication apparatus 3 during the authentication process. Since S1 to S4 are same as FIG. 2, the detailed description will not be repeated.

When the feature vector of the subject is extracted (S4), the recognition unit 14 compares each of the extracted feature vector (hereinafter, the extracted feature vector is represented as the feature vector fvT extracted from a captured image of the subject to be distinguished from the feature vectors stored in the advance information storing unit 12 or the update information storing unit 13) and the feature vectors stored in the advance information storing unit 12 and the update information storing unit 13, thereby recognizing which one of the users U1 to UN matches the subject (S11). Hereinafter, a specific example of a recognizing method will be described.

First, the recognition unit 14 calculates a similarity Skj between the feature vector fvT and the feature vector fvkj (j-th feature vector of user Uk, j=1 to M) stored in the advance information storing unit 12 and the update information storing unit 13. The similarity Skj may be considered to be a cosine similarity between the feature vector fvT and the feature vector fvkj, and described as the following formula (1).

Skj=fvT*fvkj/(|fvT|*|fvkj|) (1)

The numerator fvT*fvkj on the right side of the formula (1) is an inner product of the feature vector fvT and the feature vector fvkj. The denominators |fvT| and |fvkj| on the right side of the formula (1) are norms of the feature vectors fvT and fvkj respectively. The similarity Skj ranges from zero to 1, denoting that the feature vector fvT and the feature vector fvjk are similar to each other as the value is closer to 1.

The recognition unit 14 calculates the similarity Skj with respect to all the feature vectors fvkj stored in the advance information storing unit 12 or the update information storing unit 13.

Then, as shown in the following formula (2), the recognition unit 14 performs comparison to determine whether or not the maximum value Smax1 of the similarity Skj is greater than a predetermined threshold value (reference threshold value) T0 (S12).

Smax1=max(S11,S12 . . . )>T0 (2)

When the maximum value Smax1 is greater than a predetermined threshold value T0, the authentication is considered to have completed successfully (YES in S12). For example, when a formula of Smax1=Spl>T0 (p is any one of 1 to N, and l is arbitrary number within the range of [1, M]) comes into existence, the subject is recognized as the user Up. The recognized result is displayed in the display unit 4. As the authenticated result, the subject being the user Up, an authorized state of the user Up (whether or not the user Up may go further into the facility from the location where the authentication system is installed, and the like), personal information of the user Up and the like may be displayed thereon.

Meanwhile, when a formula of Smax1≦T0 comes into existence, the authentication is considered to have failed (NO in S12), and the authentication apparatus 3 ends the processing.

When the authentication has completed successfully (YES in S12), the update unit 15 determines whether or not the stored contents of the update information storing unit 13 are to be updated. Hereinafter, the subject is considered to be recognized as the user Up.

The update unit 15 calculates an average value (average similarity) Save of the similarities Sp1 to SpM1 between the feature vector fvT and each of the feature vectors fvp1 to fvpM1 of the user Up stored in the advance information storing unit (S13). The update unit 15 may calculate the average similarity Save by applying the similarities Sp1 to SpM1 which are calculated in S11. Then, the update unit 15 compares the average similarity Save with a predetermined threshold value (first threshold value) T1 (S14).

When the average similarity Save is equal to or smaller than the threshold value T1 (NO in S14), the update unit 15 does not update the stored contents of the update information storing unit 13, and the authentication apparatus 3 ends the processing. It is because the feature vector fvT is on average different from each of the feature vectors of the user Up which are stored in the advance information storing unit 12, even though the subject is recognized as the user Up based on the feature vector fvT.

Meanwhile, when the average similarity Save is greater than the threshold value T1 (YES in S14), the update unit 15 updates the stored contents of the update information storing unit 13. The update unit 15 acquires the number of the feature vector of the user Up which is stored in the update information storing unit 13. The number of the feature vector may be stored in the authentication apparatus 3 or may be acquired with reference to the update information storing unit 13. When the number has not reached the maximum number M2 (YES in S15), the update unit 15 additionally stores the feature vector fvT in the update information storing unit 13 (S16).

Meanwhile, when the number has reached the maximum number M2 (NO in S15), one of the feature vector stored in the update information storing unit 13 is replaced with a new feature vector fvT (S17).

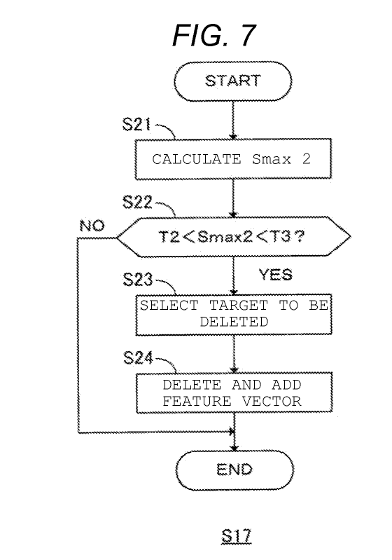

FIG. 7 is a flow chart illustrating the feature vector replacing step of FIG. 6 in detail. First, the update unit 15 calculates the maximum value Smax2 of a similarity Spk (maximum similarity) between the feature vector fvT and the feature vector fvpk (k is equal to or greater than (M1+1) being M2 at the maximum in accordance with the number of the feature vectors added to the update information storing unit 13) of the user Up which is stored in the update information storing unit 13 in advance (S21). The update unit 15 compares the maximum similarity Smax2 with predetermined threshold values T2 and T3 (second and third threshold values) (S22). When this maximum similarity Smax2 is greater than the threshold value T2 and smaller than the threshold value T3, the update unit 15 updates the stored contents of the update information storing unit 13 (YES in S22).

Meanwhile, when the maximum similarity Smax2 is equal to or smaller than the threshold value T2 (NO in S22), the update unit 15 does not update the stored contents of the update information storing unit 13. When the maximum similarity Smax2 is equal to or smaller than the threshold value T2, the feature vector fvT is considered to be lower in the similarity with the feature vectors stored in the advance information storing unit 12 than that with the feature vectors stored in the update information storing unit 13 previously. This is because the possibility of the erroneous authentication is increased if the feature vector fvT is added in such a case.

In addition, when the maximum similarity Smax2 is equal to or greater than the threshold value T3 (NO in S22) as well, the update unit 15 does not update the stored contents of the update information storing unit 13. This is because the feature vector very similar to the feature vector fvT is already stored in the update information storing unit 13 so that there is little need to additionally store the feature vector fvT.

When the stored contents of the update information storing unit 13 are updated, the update unit 15 selects a feature vector which is the most similar to other feature vectors among the feature vectors stored in advance, as a deleting target (S23). Specifically, the update unit 15 calculates a similarity Pi between an arbitrary feature vector fvpi stored in the update information storing unit 13 and another feature vector fvpj (j=M1+1 to M2, however j≠i), based on the following formula (3).

$$\begin{matrix}Expression 1 & \\ Pi = {\sum }_{j = M 1 + 1} \frac{fvpi \cdot fvpi}{\vert fvpi \vert \cdot \vert fvpi \vert} & ( 3 )\end{matrix}$$

For example, when a similarity P1 reaches the maximum, the feature vector fvp1 is a deleting target. Then, the update unit 15 deletes the feature vector which is the deleting target and adds the feature vector fvT as a new feature vector fvp1 (S24). In this manner, the stored contents of the update information storing unit 13 are updated.

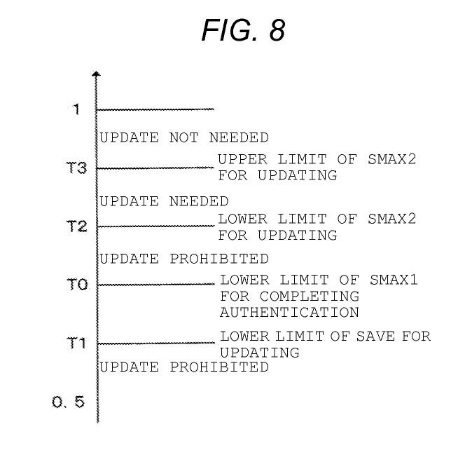

Here, the threshold values T0 to T3 will be described. FIG. 8 is a view illustrating relationships among the threshold values T0 to T3. The lower limit of the maximum similarity Smax1 to complete the authentication is the threshold value T0. It is necessary that the average similarity Save is greater than the threshold value T1 for the adding and the updating. It is preferable that the threshold value T1 be set to be smaller than the threshold value T0 and be greater than 0.5. It is possible to reduce a risk of erroneous authentication due to updating the feature vector by providing the threshold value T1.

In addition, it is necessary that the maximum similarity Smax2 is greater than the threshold value T2 for updating. The threshold value T2 is set to be greater than the threshold value T0. When the updating is performed when the maximum similarity Smax2 is equal to or smaller than the threshold value T2, there is a possibility of the occurrence of the erroneous authentication. Moreover, it is necessary that the maximum similarity Smax2 is smaller than the threshold value T3 for the updating. The threshold value T3 is set to be smaller than 1. Unnecessary updating is prevented by providing the threshold value T3.

Each threshold value may be determined based on an experimental result by practically performing the authentication with respect to the users U1 to UN or may be determined based on another experimental result using a general database of the face images which are disclosed.

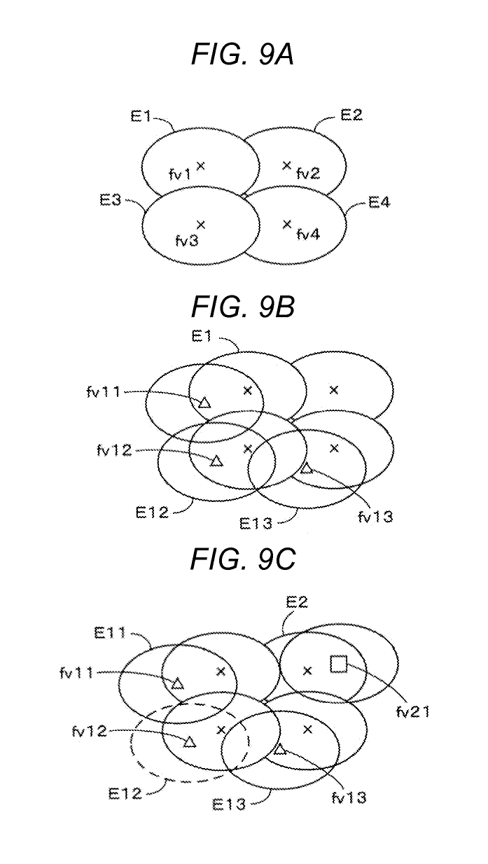

FIGS. 9A to 9C are views illustrating an effect of updating the feature vector. Here, it is considered that four feature vectors are stored in the advance information storing unit 12 in advance with respect to a certain user (M1=4), and a maximum of three feature vectors are possible to be additionally stored in the update information storing unit 13 (M2=3).

FIG. 9A schematically illustrates four feature vectors (X marks fv1 to fv4) of a certain user which are registered in the advance information storing unit 12 in advance and a range (ovals E1 to E4 having X mark as center) of a user which is recognizable through each feature vector. The authentication apparatus 3 may recognize the user within a range which the ovals E1 to E4 cover.

In contrast, FIG. 9B schematically illustrates three added feature vectors (Δ marks fv11 to fv13) of the user and a range (ovals E11 to E13 having Δ mark as center) of the user which is recognizable through the feature vector thereof. For example, since the feature vector fv11 is included in the oval E1, the feature vector fv11 is recognized to match the user. In addition, since the feature vector fv11 fulfills the condition to be added to the update information storing unit 13, the oval E11 having the feature vector fv11 as the center is added to the update information storing unit 13. In this manner, it is possible to widen the recognizable range by adding the feature vector, and it is also possible to recognize a user even when the face of the user is changed due to aging.

FIG. 9C illustrates replacing of the feature vectors. A feature vector fv21 (□ mark) is included in the oval E2, thereby being recognized to match the user. Here, in order to additionally store the feature vector fv21, it is necessary to delete any one of the feature vectors fv11 to fv13. In the case of FIG. 9C, the oval E12 is adjacent to both of the ovals E11 and E13. Accordingly, the update unit 15 deletes the feature vector fv12 which is the center of the oval E12 and newly adds the feature vector fv21.

In FIGS. 9B and 9C, there is no possibility that the feature vectors fv1 to fv4 stored in the advance information storing unit 12 is deleted. Therefore, new feature vector is added with the feature vectors fv1 to fv4 stored in the advance information storing unit 12 as the central figures. Accordingly, it is possible to prevent the authentication rate from being lowered due to the successive occurrence of the erroneous authentication.

In this manner, in the first embodiment, the authentication is performed using the feature vectors stored in the advance information storing unit 12 in advance and the feature vectors stored in the update information storing unit 13. Then, the stored contents of the update information storing unit 13 is updated in response to the authenticated result. Therefore, the accuracy of the authentication may be improved. In addition, the stored contents of the update information storing unit 13 is updated without updating the stored contents of the advance information storing unit 12. Therefore, it is possible to reduce the risk of the erroneous authentication.

### Second Embodiment

In a second embodiment, in consideration of not only the similarity between the feature vector of the subject and the feature vectors of the recognized users, but also the similarity between the feature vector of the subject and the feature vectors of other users, it is determined whether or not the stored contents of the update information storing unit 13 are to be updated. Hereinafter, the description will be given with focusing on the difference with respect to the first embodiment.

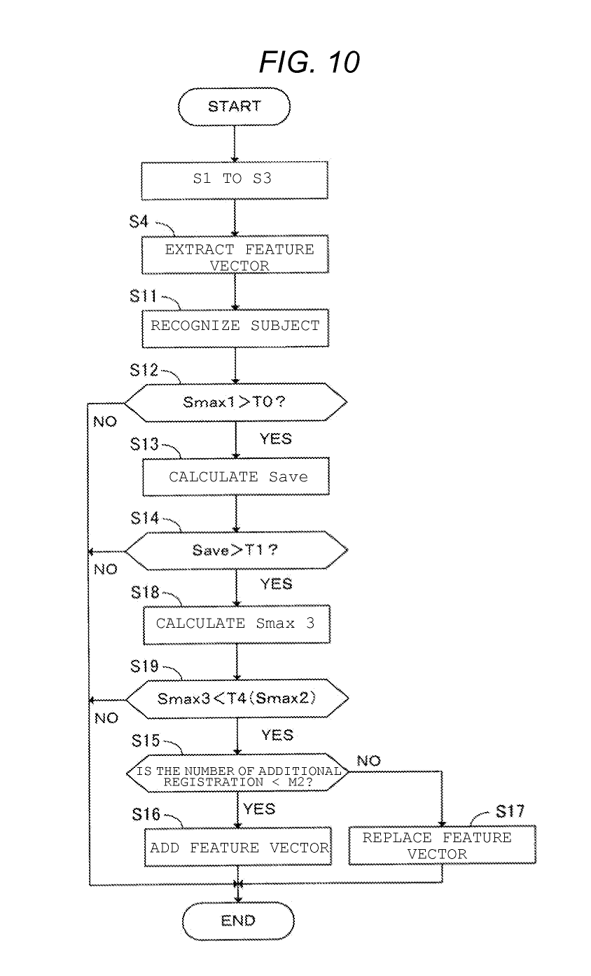

FIG. 10 is a flow chart illustrating an example of the processing of the authentication apparatus 3 in the authentication process according to the second embodiment. When the average similarity Save is greater than the threshold value T1 (YES in S14), the update unit 15 calculates the maximum value Smax3 of the similarity Spk (maximum similarity) between the feature vector fvT and the feature vector fvkj (j=M1 to M2) of the user Uk (k=1 to N and k≠p) other than the user Up (the user recognized by the recognition unit 14) which is stored in the update information storing unit 13 previously (S18).

Then, the update unit 15 compares the maximum similarity Smax3 with a threshold value T4 (fourth threshold value) (S19). When the maximum similarity Smax3 is greater than the threshold value T4 (NO in S19), the update unit 15 does not update the stored contents of the update information storing unit 13. The reason is because the feature vector fvT is similar to the feature vector of a user different from the recognized user, and thus, the updating increases the risk of the erroneous authentication.

Meanwhile, when the maximum similarity Smax3 is smaller than the threshold value T4 (YES in S19), the update unit 15 updates the stored contents of the update information storing unit 13 in a manner similar to the first embodiment (S15 to S17).

Here, the threshold value T4 may be a value determined in advance. Otherwise, the threshold value T4 may dynamically vary as being the threshold value T4=Smax2. In S19, the condition that the Smax3 is smaller than the Smax2 signifies that the feature vector fvT is the most similar to the feature vector of the user Up than that of other users.

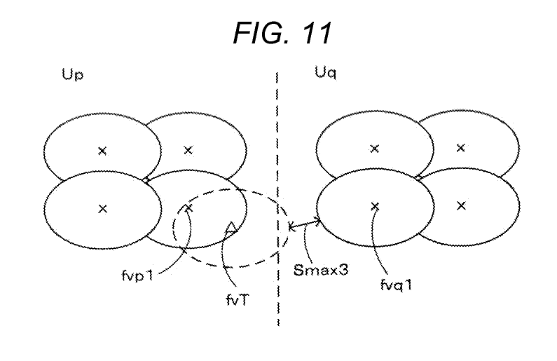

FIG. 11 is a conceptual diagram illustrating an effect of the second embodiment. In FIG. 11, the feature vector fvT extracted from the captured image of the subject is the most similar to a feature vector fvp1 of the user Up, thereby recognizing the subject as the user Up. Incidentally, the feature vector fvT has a high similarity Smax3 with respect to a feature vector fvq1 of another user Uq.

In this case, if the feature vector fvT is added to the update information storing unit 13 as the user Up, the user Uq may be erroneously authenticated to be the user Up. Therefore, in the second embodiment, when the similarity Smax3 is high with respect to the user Uq which is different from the recognized user Up, the feature vector fvT thereof is not added.

In this manner, in the second embodiment, the authentication is performed in consideration of the similarity with respect to the feature vector of other users different from the recognized user. Therefore, the risk of the erroneous authentication may be further reduced.

The advance information storing unit 12 and the update information storing unit 13 are described to be separate units in the configuration, but the advance information storing unit 12 and the update information storing unit 13 may be managed by dividing the region of the same storage unit. In addition, the subject is described to be a human being, but any subject may be applicable as long as the subject may be recognized.

At least a portion of the authentication system described in the above embodiments may be configured with hardware or may be configured with software. In a case of the configuration with the software, a program to realize a function of at least the portion of the authentication system may be accommodated in a recording medium such as a flexible disk or a CD-ROM to be read by a computer, thereby being executed. The recording medium may be a fixed-type recording medium such as a hard-disk device or a memory, without being limited to an attachable-detachable recording medium such as a magnetic disk or an optical disk.

In addition, a program that achieves a function of at least the portion of the authentication system may be distributed through a communication channel (including wireless communication) such as the Internet. Moreover, the program may be in a state of being encrypted, modulated or compressed to be distributed through a wire or a wireless circuit such as the Internet or distributed by being stored in a recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An authentication apparatus comprising:
first and second storage units in which feature data of different authentication targets are stored;
a feature extraction unit configured to extract feature data of a subject from an image including the subject;
a recognition unit configured to compare the extracted feature data of the subject with the feature data of the authentication targets stored in the first storage unit and the second storage unit to generate similarity results, and recognize one of the authentication targets as the subject based on the comparison results; and
an update unit configured to update the feature data stored in the second storage unit with the extracted feature data of the subject based on the comparison results.

2. The apparatus according to claim 1,
wherein the update unit is configured to determine whether or not the second storage unit is to be updated by comparing an average value of a similarity between the extracted feature data of the subject and each feature data of the recognized authentication target which is stored in the first storage unit with a first threshold value.

3. The apparatus according to claim 2,
wherein the update unit is configured to add the extracted feature data of the subject to the second storage unit when a number of the feature data of the recognized authentication target stored in the second storage unit is smaller than a first number, and
the update unit replaces one of the feature data stored in the second storage unit with the extracted feature data of the subject when the number of the feature data of the recognized authentication target stored in the second storage unit is equal to the first number.

4. The apparatus according to claim 3,
wherein when the maximum value of a similarity between the extracted feature data of the subject and each feature data of the recognized authentication target which is stored in the second storage unit is greater than a second threshold value and smaller than a third threshold value, the update unit replaces one of the feature data of the recognized authentication target stored in the second storage unit with the extracted feature data of the subject.

5. The apparatus according to claim 4,
wherein when the maximum value of a similarity between the extracted feature data of the subject and each feature data of the recognized authentication target which is stored in the second storage unit is less than the second threshold value or greater than the third threshold value, the update unit does not replace one of the feature data of the recognized authentication target stored in the second storage unit with the extracted feature data of the subject.

6. The apparatus according to claim 4,
wherein the update unit is configured to replace a feature data of the recognized authentication target stored in the second storage unit which has the highest similarity to other feature data of the recognized authentication target stored in the second storage unit, with the extracted feature data of the subject.

7. The apparatus according to claim 2,
wherein the update unit is configured to determine whether or not the second storage unit is to be updated by comparing the maximum value of a similarity between the extracted feature data of the subject and each feature data of the authentication targets other than the recognized authentication target with a fourth threshold value.

8. The apparatus according to claim 1, wherein the feature data of the authentication targets stored in the first storage unit are maintained as fixed data.

9. An authentication system comprising:
a camera that captures a subject and forms an image including the subject;
first and second storage units in which feature data of different authentication targets are stored;
a feature extraction unit that extracts a feature data of the subject from the image including the subject;
a recognition unit configured to compare the extracted feature data of the subject with the feature data of the authentication targets stored in the first storage unit and the second storage unit to generate similarity results, and recognize one of the authentication targets as the subject based on the comparison results;
an update unit configured to update the feature data stored in the second storage unit with the extract feature data of the subject based on the comparison results; and
an output unit configured to output a notification that the subject has been successfully recognized.

10. The system according to claim 9,
wherein the update unit is configured to determine whether or not the second storage unit is to be updated by comparing an average value of a similarity between the extracted feature data of the subject and each feature data of the recognized authentication target which is stored in the first storage unit with a first threshold value.

11. The system according to claim 10,
wherein the update unit is configured to add the extracted feature data of the subject to the second storage unit when a number of the feature data of the recognized authentication target stored in the second storage unit is smaller than a first number, and
the update unit replaces one of the feature data stored in the second storage unit with the extracted feature data of the subject when the number of the feature data of the recognized authentication target stored in the second storage unit is equal to the first number.

12. The system according to claim 11,
wherein when the maximum value of a similarity between the extracted feature data of the subject and each feature data of the recognized authentication target which is stored in the second storage unit is greater than a second threshold value and smaller than a third threshold value, the update unit replaces one of the feature data of the recognized authentication target stored in the second storage unit with the extracted feature data of the subject.

13. The system according to claim 12,
wherein when the maximum value of a similarity between the extracted feature data of the subject and each feature data of the recognized authentication target which is stored in the second storage unit is less than the second threshold value or greater than the third threshold value, the update unit does not replace one of the feature data of the recognized authentication target stored in the second storage unit with the extracted feature data of the subject.

14. The system according to claim 12,
wherein the update unit is configured to replace a feature data of the recognized authentication target stored in the second storage unit which has the highest similarity to other feature data of the recognized authentication target stored in the second storage unit, with the extracted feature data of the subject.

15. The system according to claim 10,
wherein the update unit is configured to determine whether or not the second storage unit is to be updated by comparing the maximum value of a similarity between the extracted feature data of the subject and each feature data of the authentication targets other than the recognized authentication target with a fourth threshold value.

16. The system according to claim 9, wherein the feature data of the authentication targets stored in the first storage unit are maintained as fixed data.

17. An authentication method comprising:
extracting a feature data of a subject from an image including the subject;
comparing the extracted feature data of the subject with the feature data of the authentication targets previously generated, to generate similarity results, and recognizing one of the authentication targets as the subject based on the comparison results; and
updating the feature data stored in the second storage unit with the extracted feature data of the subject based on the comparison results.

18. The method according to claim 17,
prior to said updating, comparing an average value of a similarity between the extracted feature data of the subject and each feature data of the recognized authentication target which is stored in the first storage unit with a first threshold value to determine that said updating is to be carried out.

19. The method according to claim 18,
wherein said updating includes adding the extracted feature data of the subject to the second storage unit when a number of the feature data of the recognized authentication target stored in the second storage unit is smaller than a first number, and replacing one of the feature data stored in the second storage unit with the extracted feature data of the subject when the number of the feature data of the recognized authentication target stored in the second storage unit is equal to the first number.

20. The method according to claim 19, wherein
when the maximum value of a similarity between the extracted feature data of the subject and each feature data of the recognized authentication target which is stored in the second storage unit is greater than a second threshold value and smaller than a third threshold value, one of the feature data of the recognized authentication target stored in the second storage unit is replaced with the extracted feature data of the subject, and
when the maximum value of a similarity between the extracted feature data of the subject and each feature data of the recognized authentication target which is stored in the second storage unit is less than the second threshold value or greater than the third threshold value, one of the feature data of the recognized authentication target stored in the second storage unit is not replaced with the extracted feature data of the subject.
